(19) United States
(12) Patent Application Publication
(10) Pub. No.: US 2026/0028073 A1
(43) Pub. Date: Jan. 29, 2026

(54) Legged Robot with Joint-Augmented Stability Control

(71) Applicant: Anish Mampetta, Sunnyvale, CA (US)

(72) Inventor: Anish Mampetta, Sunnyvale, CA (US)

(21) Appl. No.: 19/270,498

(22) Filed: Jul. 16, 2025

Related U.S. Application Data
(60) Provisional application No. 63/675,733, filed on Jul. 26, 2024.

(51) Int. Cl. B62D 57/032; G05D 17/00

(52) U.S. Cl. CPC B62D 57/032; G05D 17/00

(57) ABSTRACT

A robot may include a torque generator to generate a torque, and a leg system including one or more legs movably coupled to and supporting the torque generator. Each leg of the one or more legs may include a first leg member, a second leg member, a first joint movably coupling the first leg member and the second leg member, and a first linear elasticity element coupled between the first leg member and the second leg member across the first joint. The first linear elasticity element may be disposed to provide a first force when the first linear elasticity element is actuated that, in combination with the torque, facilitates maintaining an upright position of the bipedal robot.

This application claims the benefit of U.S. provisional patent application No. 63/675,733, filed on Jul. 26, 2024, which is incorporated by reference herein in its entirety.

### FIELD

This disclosure relates to the field of robotics, and more particularly, to an architecture for a bipedal robot and a balancing legged robot with one or more legs.

### BACKGROUND

Traditionally, bipedal robot designs have mimicked human anatomy and functionality. For instance, the degrees of freedom on the leg are usually similar to a human leg and located approximately where the human joints are located. A hip joint with three degrees of freedom, a knee with one degree of freedom and the ankle joint with two degrees of freedom are typical. Balance of the torso is maintained by precisely controlling the torque generated by the joints in the leg, which is similar to how a human balances. Balancing is augmented by controlling the net momentum generated by the torso and the arms, which is also typical of humans. Overall, bipedal robot designs are biologically and anthropomorphically inspired. However, such designs have some limitations.

One limitation is that human muscles have considerably more torque density and considerably more agility than electrical actuators. Hence, a gearbox is typically used to increase the torque density of the actuators, but this reduces the agility of the joint due to velocity saturation and other non-linearities such as backlash, hysteresis and friction in the gearbox. Therefore, a compromise is made between the torque density and agility of the joint. Moreover, using a gearbox increases the weight and cost, and decreases the reliability of the system.

Another limitation of biologically inspired design relates to the fact that humans have evolved highly sensitive sensory features in the feet, that are capable of precise contact sensing, which is used as a feedback to regulate balancing. This level of sensing is not feasible in an electro-mechanical system. Hence a biologically inspired design is unlikely to produce a machine with balancing capabilities similar to a human.

A different approach to bipedal robot design, generally described as non-anthropomorphic design, is described in the paper, Gyrubot: non anthropomorphic stabilization for a biped, Nikita et. al. IEEE Int. Con. on Robotics and Automation, May 2021, hal-03172031 (“Gyrubot”). In this approach a control moment gyroscope located in the torso of the robot is used to generate balancing torque to stabilize the robot, instead of relying on the leg to generate the balancing torque. Similar designs are described in U.S. patent application publication no. 2021/0379774 and in U.S. Pat. No. 6,527,071.

### BRIEF DESCRIPTION OF THE DRAWINGS

One or more implementations of the present disclosure are illustrated by way of example and not limitation in the figures of the accompanying drawings, in which like references indicate similar elements.

FIG. 1 is a schematic diagram illustrating principles of a robot architecture introduced here, with a robot leg and torso system in a vertical upright position.

FIG. 2A is a schematic diagram illustrating principles of the robot architecture introduced here, with a robot leg and torso system in a vertical upright position.

FIG. 2B is a schematic diagram illustrating principles of the robot architecture introduced here, where the system has been offset from vertical due to a perturbation.

FIG. 2C is a schematic diagram illustrating principles of the robot architecture introduced here, where the system has recovered from the perturbation in FIG. 2B.

FIG. 3A is a variation on the implementation in FIG. 2A, but including an additional knee joint and a spring at the knee joint.

FIG. 3B shows a configuration where the knee and ankle are each bent to cause compression of the knee spring and extension of the ankle spring.

FIG. 4 shows two reaction wheels disposed at an angle relative to each other.

FIG. 5 shows a sagittal plane and a frontal plan of a humanoid robot.

FIG. 6 shows a detailed implementation of a humanoid bipedal robotic system incorporating the robot architecture introduced here.

FIG. 7A illustrates a front-offset perspective view of an example of the details of a leg of the humanoid system shown in FIG. 6.

FIG. 7B illustrates a side view of an example of the details of a leg of the humanoid system shown in FIG. 6.

FIG. 7C illustrates a rear-offset perspective view of an example of the details of a leg of the humanoid system shown in FIG. 6.

FIG. 8A is a side-offset perspective view of an example of the details of the reaction wheel module shown in FIG. 6.

FIG. 8B is a front view of an example of the details of the reaction wheel module shown in FIG. 6.

### DETAILED DESCRIPTION

In this description, references to “an implementation”, “one implementation” or the like, mean that the particular feature, function, structure or characteristic being described is included in at least one implementation of the technique introduced here. Occurrences of such phrases in this specification do not necessarily all refer to the same implementation. On the other hand, the implementations referred to also are not necessarily mutually exclusive. Introduced here is an architecture and technique (hereinafter “the technique”) for a non-anthropomorphic robot (unipedal, bipedal, or multipedal), which addresses some of the limitations of existing non-anthropometric design approaches. A goal of the technique is to create a practical design that enables better balancing of the robot.

A premise underlying the technique is that mimicking biological design may not be the best approach to design at least some complex machines. For instance, though flying was inspired by birds, a practical airplane does not have flapping wings. This is because mechanical systems cannot presently match the torque density and performance of biological muscles. Similarly, an automobile does not have mechanical legs similar to a horse. In the same spirit, an improved bipedal robot design may be one that deviates from biological principles and biological constraints, as described below.

In the Gyrubot non-anthropometric bipedal robot design (referenced above), the torso is balanced entirely by the torques generated by the control moment gyroscopes. However, that requires a large gyroscope, as shown in the paper. This is because the torque generated by the gyroscope is proportional to the product of the inertia of the gyroscope flywheel and the speed at which the flywheel rotates. Hence, one way to increase the torque output is to increase the size of the flywheel, which in turn increases the inertia. Alternatively, a smaller gyroscope that spins at higher speeds can be used.

Both approaches have practical constraints, the first with the size and weight of the gyroscope, and the second with the practical challenges of generating and maintaining high gyroscope speeds without vibration and wear. In addition, the gyroscopes store a large amount of kinetic energy, which is not conducive to safety while operating around people. In the event of a failure, the stored energy will be released, which poses a safety hazard to immediate surroundings and people around the system.

In the technique introduced here, a combination of mechanical elements are strategically used to create a practical non-anthropometric robot design. In at least one implementation, a combination of a torque generator and one or more strategically placed linear elasticity elements is used. The torque generator may include one or more flywheels and/or control moment gyroscopes to help maintain stability of the robot. The linear elasticity elements may include one or more springs, rubber or elastomer bands, or the like, that also help maintain stability and enable direct-drive actuators to be used for the active leg joints. In at least some implementations, one or more of the linear elasticity elements are bidirectional, in that they have elasticity in both extension and compression.

Note that a control moment gyroscope typically has more torque density than a reaction wheel. That is, a gyroscope can produce more torque for a given mass and size than a reaction wheel. Hence, to achieve the same torque output as a gyroscope, a larger reaction wheel would be needed, which is not conducive for use on a bipedal robot due to size constraints. However, this limitation is overcome in the technique introduced here by using strategically located linear elasticity elements, such as springs, to compensate for the limited torque from the reaction wheel, hence keeping the size of the reaction wheel relatively small. Hence, in one implementation of the technique introduced here, one or more reaction wheels are used in conjunction with one or more strategically located linear elasticity elements, such as springs, to maintain balance.

A reaction wheel typically comprises a flywheel attached to a motor. It operates based on the law of conservation of angular momentum. The motor can accelerate or decelerate the flywheel, thus changing its angular momentum. When the flywheel is accelerated (positively or negatively), it gains angular momentum. To conserve the total angular momentum of the system, it produces a reaction torque, opposite to the direction of acceleration. In the technique introduced here, the torque generated by one or more reaction wheels is used to help stabilize a legged robot.

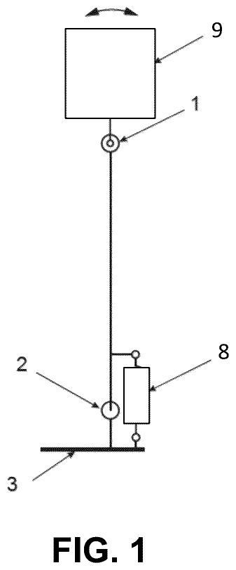

This technique is illustrated conceptually in FIGS. 1 through 5. In a simple example, a robot system according to the technique introduced here includes at least one leg, with each leg including a single active joint at the hip joint (“hip”) 1, a passive ankle joint (“ankle”) 2, a foot 3 distal to the ankle joint 2, and a linear elasticity element 8 across the ankle joint 2, and where the robot system further includes a torque generator 9 mounted above the hip 1. An “active” joint is a joint that has actuation powered by one or more components (e.g., a motor/actuator) on the robot. Note that while only a single leg is shown in FIGS. 1 through 3, a robot in accordance with the technique introduced here may include one leg or multiple legs conforming to this description. Also note, however, that an implementation with only a single leg (i.e., unipedal) may be particularly useful in certain applications. For example, a hopping unipedal design may be mechanically less complex and lighter than a bipedal design, for example, and therefore may be particularly well suited for applications in low-gravity environments, such as in outer space.

In at least one implementation, the linear elasticity element 8 is a spring, as is generally assumed henceforth in this description to facilitate explanation. In other implementations, however, the linear elasticity element 8 could be, for example, an elastic band made of, for example rubber or elastomer. In at least some implementations, the torque generator 9 may be or include, for example, one or more reaction wheels, as also generally assumed henceforth in this description to facilitate explanation. In other implementations, however, the torque generator 5 could be or include, for example, one or more control moment gyroscopes.

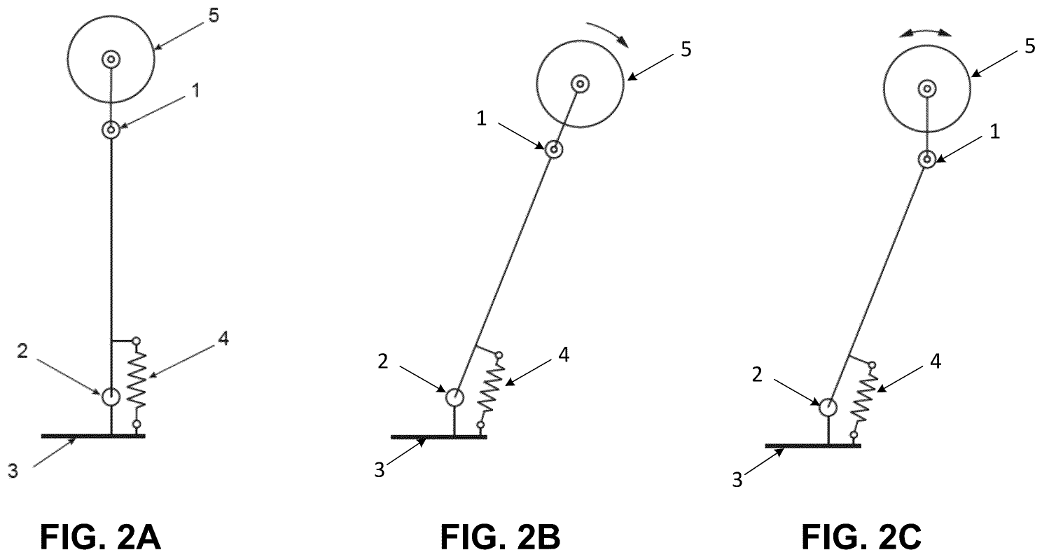

In the implementations shown in the remaining figures, the linear elasticity element 8 is or includes at least one spring, and the torque generator 9 is or includes at least one reaction wheel. Referring now to FIGS. 2A, 2B and 2C, a reaction wheel 5 and the hip joint 1 are actuated by a motor (not shown) co-located with the reaction wheel 5 and the hip joint 1, respectively.

In a simple implementation of this technique, the reaction wheel 5 forms the torso of the robot. The spring 4 is located at the ankle 2 to aid in keeping the leg upright. When there is no external perturbation, the spring force is sufficient to keep the leg upright. The torque provided by the hip motor maintains the reaction wheel 5 upright. The reaction wheel 5 provides the additional torque required to recover from external perturbations (FIG. 2C).

Note that at the vertical upright position (FIG. 2A), the hip joint 1 will not experience any torque due to the weight of the reaction wheel 5 as the weight vector passes directly through the axis of the hip joint 1. When the leg is offset from the vertical, as shown in FIG. 2B, the reaction wheel 5 is commanded to maintain the position of the torso vertically above the hip joint, as shown in FIG. 2C. In at least some implementations, the spring 4 is bidirectional, i.e., it provides a spring force in both extension and compression. The effect of the bidirectional spring 4 at the ankle 2 is to always bring the leg back to an upright position (per FIG. 2A). However, when recovering from a large perturbation, the force generated by the spring may cause an overshoot. In this case, the reaction wheel can be commanded to produce a counter-damping torque to stabilize the system.

In at least some implementations, control of the reaction wheel (e.g., the above-mentioned commands) can be accomplished by using a closed-loop control system (not shown), in which an inertial measurement unit (IMU) located in (for example) the torso is used to measure the angular deviation of the torso from the vertical as well as the rate of change of deviation from the vertical. That information can then be used to implement a feedback control system using, for example, a proportional-integral-derivative (PID) controller that commands the reaction wheel motor to produce the appropriate torque to stabilize the system. The control law may be implemented in an on-board computer or microcontroller, for example.

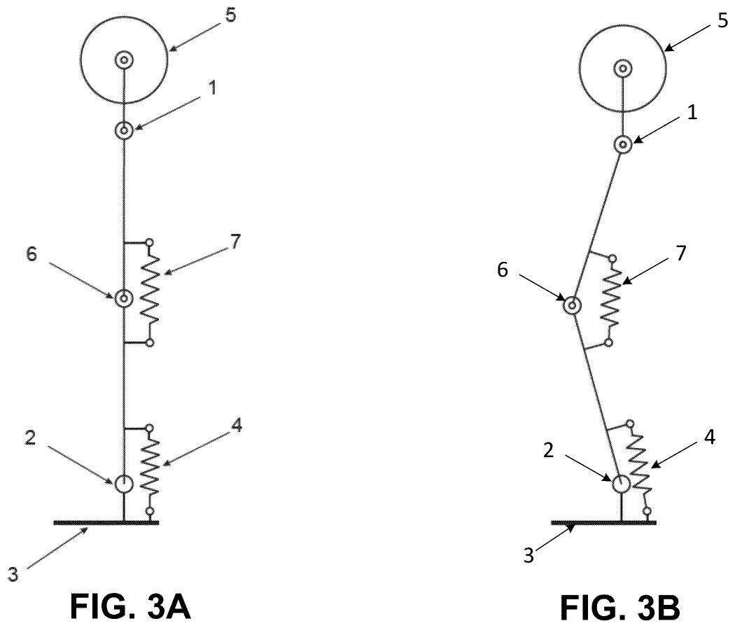

FIGS. 3A and 3B expand on the above-described technique to add an active knee joint (“knee”) 6 with a motor (not shown) co-located at the joint. A bidirectional spring 7 is provided across the knee joint 6 to reduce the torque required from the knee joint 6. When the knee 6 is upright and not activated, the spring 7 keeps the leg stable, as shown in FIG. 3A. When the knee 6 is actuated, the spring supplements the motor-provided torque at the knee, as shown in FIG. 3B. This represents a full leg, capable of moving the torso to any point in a plane. The system can recover to the statically stable upright position (FIG. 3A) from any point in the planar configuration space.

The spring 4 at the ankle 2 reduces the torque requirement on the reaction wheel 5. Hence, only a moderately sized reaction wheel is required, making this concept feasible. The size of the reaction wheel 5 can easily fit into the envelope of a human form factor. This fact is significant, because if a large amount of torque were required from the reaction wheel, a larger motor and proportionally large reaction wheel would be required. If the size of the reaction wheel were to be reduced, the reaction wheel would accelerate faster and hit velocity saturation quickly, thereby losing its effectiveness. Hence, using (at least) a strategically located spring at the ankle (and optionally one at the knee) to reduce the torque needed from the reaction wheel makes this approach feasible.

As discussed above, the hip 1 does not typically experience any torque from the weight of the torso. Hence, the torque requirement is quite low. Additionally, the spring 7 located at the knee 6 (FIGS. 3A and 3B) reduces the torque requirement on the knee actuator. Hence, the use of a reaction wheel for balancing, and strategically located springs for torque compensation, reduces the torque requirement on the knee and hip joints. It reduces the torque requirement to a point where it is feasible to use direct-drive actuators at the knee and hip joints. This is a significant advantage, because it is now possible to implement a bipedal robot system with direct-drive actuation on all active leg joints.

Traditional humanoid robots, in which torque is entirely generated at the joints, require a large amount of torque at the joints to maintain balance. Electrical actuators do not have the torque density to meet this demand. Hence, a gearbox is used to increase the torque density. That approach comes with numerous disadvantages. First, it increases the cost and complexity of the system. Second, it reduces the speed output, leading to velocity saturation and reduced agility. Third, it reduces the ability of the leg to sense torque, due to the effect of the reflected inertia. Finally, it leads to reduced operating life and reduced reliability due to wear and tear of the gearbox.

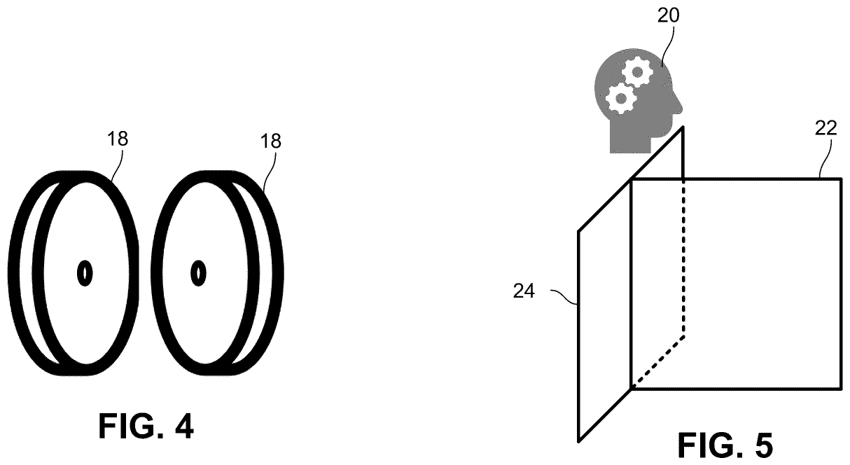

Every flywheel has an axis of rotation, i.e., the axis about which it rotates. A flywheel is said to “rotate in,” to be “positioned in,” “disposed in,” or simply to “be in,” a plane of rotation. The plane of rotation of a flywheel is the plane that is perpendicular to the flywheel's axis of rotation. In some implementations of the technique introduced here, a humanoid robot is stabilized by a pair of flywheels 18 whose planes of rotation are not parallel to each other, as illustrated in FIG. 4. Further, in some implementations, the planes of rotation of the flywheels may be oriented in relation to orthogonal planes that are defined relative to the structure of a humanoid robot 20, such as a sagittal plane 22 and a frontal plane 24 of the robot 20, as shown in FIG. 5. For example, one reaction wheel may rotate in the sagittal plane 22 while the other reaction wheel rotates in the frontal plane 24. The two reaction wheels in such an implementation work in synchronization to produce torque in the sagittal plane 22 and in the frontal plane 24. The reaction wheel that rotates in the sagittal plane 22 provides stability in the sagittal plane 22 to the robot. It maintains static stability when the robot is not moving forward or backward. When the robot 20 is moving forward, the reaction wheel that rotates in the sagittal plane 22 provides a pitching action to lean the body of the robot (not shown) forward.

In some implementations, the reaction wheels may be placed so that their planes of rotation are at an acute angle relative to each other, such as 30 degrees, 45 degrees or 60 degrees. Such a configuration can provide more compact, more symmetrical packaging and weight distribution. In such a configuration, the net torque produced in one plane is more than the torque produced in the other plane. Depending on the requirement, various angles between the reaction wheels' planes of rotation are possible.

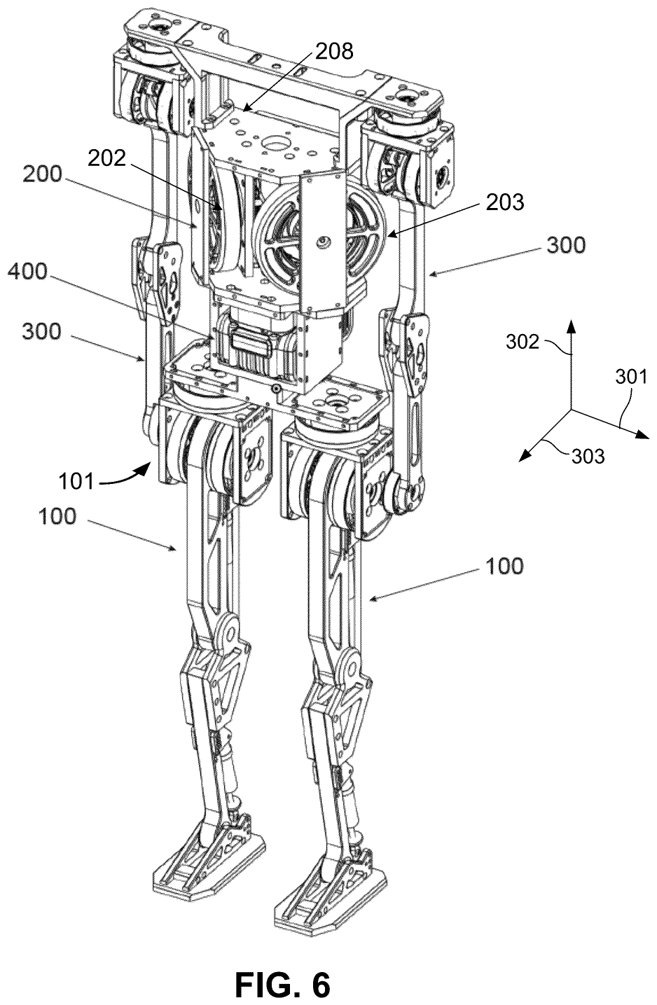

With the non-anthropometric design approach introduced here, it is possible to implement a bipedal system with direct-drive actuation on all active joints. FIG. 6 shows an implementation of a humanoid system with two legs 100, a torso 200, and two arms 300. The core elements in this implementation are the legs 100 and the torso 200. Arms 300 are optional and are included here to show a complete humanoid system. The head is not shown.

In the bipedal robot implementation of FIG. 6, two reaction wheels 202, 203 are located within the torso 200 and are disposed perpendicular to each other. The reaction wheels 202, 203 are actuated by motors (not shown) co-located along the axes of rotation of the reaction wheels 202, 203. A battery pack 400 is located between the hip region 101 and the reaction wheels 202, 203, however, the location of the battery pack is not germane to this disclosure; that is, it can be located anywhere in the torso 200 of the robot.

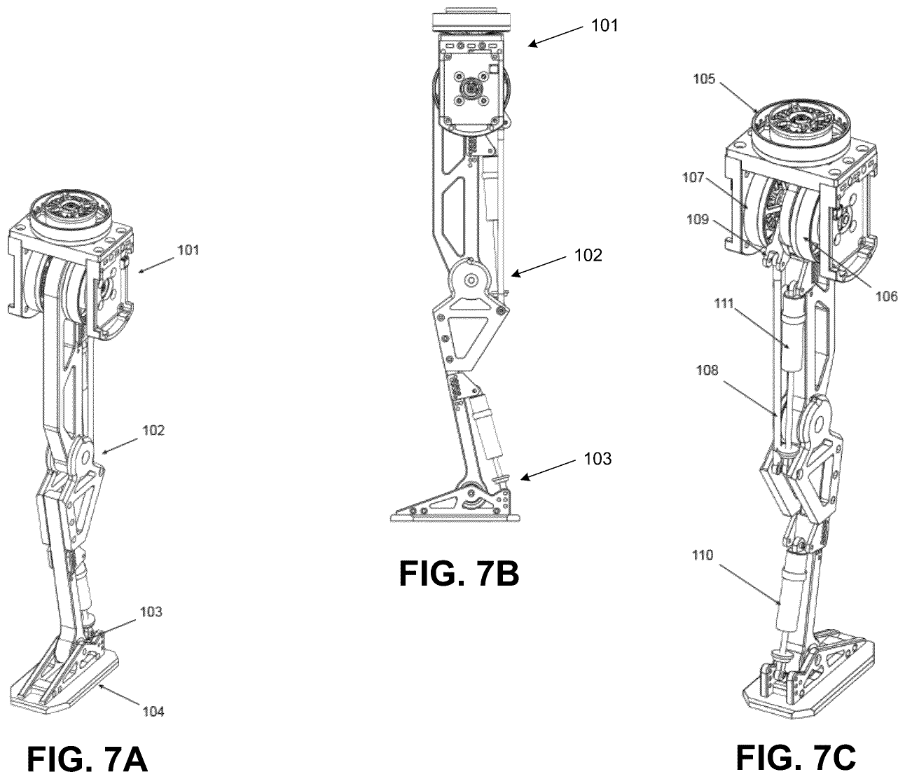

FIGS. 7A, 7B and 7C show an example of the details of a leg 100 of the robot. In this implementation, each leg includes: a hip region 101 with two degrees of freedom; a knee 102 with one degree of freedom, an ankle 103 with one degree of freedom, and a foot 104 distal to the ankle 103. The hip region 101 is actuated using direct-drive electric actuators 105, 106. The knee 102 is also direct-drive in effect, but actuator 107 is placed at the hip region 101 in this implementation, and the resulting motion is transmitted to the knee 102. This is done to reduce inertia of the leg. Motion is transmitted to the knee 102 in this implementation by a 4-bar linkage including a drive shaft 108 and crank 109, but it could very well be a belt or chain drive or some other transmission mechanism. The ankle 103 has one passive degree of freedom. A spring 110 between the shin and the feet keeps the shin upright. Another spring 111 between the thigh and the shin keeps the thigh upright.

In the leg of FIGS. 7A through 7C, the active joints are direct-drive, in contrast with a traditional humanoid leg. Also, the ankle joint is passive, in contrast with a traditional humanoid leg. These features make the leg considerably lighter and of considerably lower inertia than a typical humanoid leg. The leg can therefore be light enough that the limited torque available from the direct-drive actuators at the hip and knee are sufficient to swing the leg during walking or running. As indicated above, in other implementations, one or more of the springs mentioned above may be replaced by a different type of linear elasticity element, such as an elastic (e.g., rubber or elastomer) band.

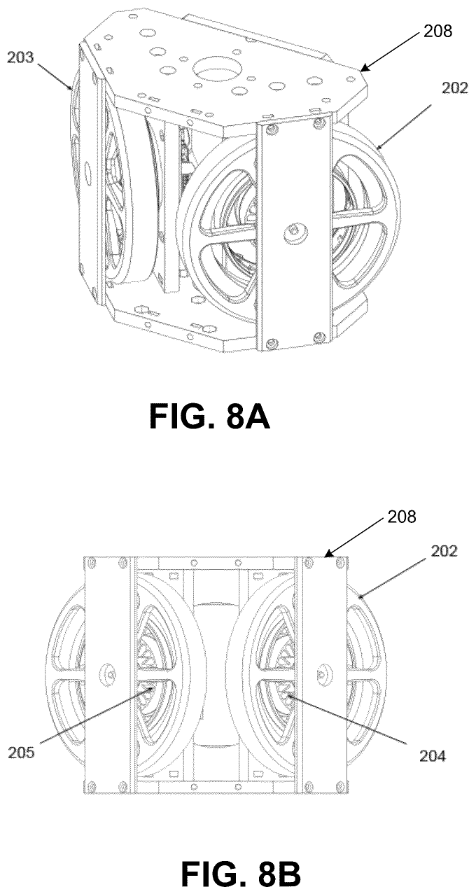

FIGS. 8A and 8B show in greater detail an example of the reaction wheels 202, 203 located in the torso 200 of the robot. As shown, the reaction wheels 202, 203 can be rotatably mounted within a reaction wheel module 208, which is mounted within the torso 200 of the robot as shown in FIG. 6, and which may be formed from a set of connected brackets. In the illustrated implementation, the reaction wheels 202, 203 are mounted orthogonal to each other within the reaction wheel module 208. The reaction wheels 202, 203 are actuated by direct-drive electrical actuators 204, 205, respectively, in this implementation. Each actuator 204, 205 can be located inside the profile of the corresponding reaction wheel 202, 203 for compact packaging, as shown. The reaction wheels 202, 203 can produce balancing torque in the pitch axis 301 and the yaw axis 302 of the robot.

Three operating modes of the robot are now considered: static balancing, dynamic balancing, and walking. In the static balancing mode, the actuators in the legs can be turned off. Typically, the springs in the ankle and the knee are sufficient to keep the robot upright. If there is an off-balance weight on the torso, due to, for example, the placement of the battery, the torque produced by the reaction wheels will move the torso in the pitch axis 301 to bring the center of gravity (CG) of the torso 200 in alignment with the ankle. This is automatically handled by the control law implemented on the reaction wheel, which is commanded to keep the torso upright. The control law can be a linear-quadratic regulator (LQR) or a cascaded PID loop, for example. An IMU (not shown) located in the torso can be used to compute the orientation of the robot in real time and used as the feedback for the control law.

In the dynamically stable mode, the system can reject external perturbations. In this mode, the system actively uses the reaction wheels 202, 203 in conjunction with the torque produced at the joints to maintain balance. The robot may also step away using the legs to compensate for large perturbations.

In the walking mode, the reaction wheels 202, 203 are used to yaw the CG of the robot over one leg and the other leg is used to initiate a step. In a simple walking mode, two independent control laws can be used. The reaction wheels keep the torso 200 upright using, for example, a LQR or PID based torque control law. The legs can operate independently of the reaction wheels using a position based control law. Unlike the traditional humanoid where the leg operates in torque mode, the leg in this approach is operated in a position control mode, which makes the control considerably simpler. That is, the legs can follow a pure position trajectory while the reaction wheels 202, 203 maintain the balance. Hence in a simple implementation, two independent controllers can be used, e.g., a balancing torque controller for the reaction wheel(s) and an independent position control loop for the leg system.

In the implementation shown in FIG. 6, each hip region 101 includes two joints (“hip joints”), an upper hip joint and a lower hip joint, each of which has one degree of freedom. Hence, the hip region 101 as a whole has two degrees of freedom. In at least one implementation, the orientation of the hip joints of a hip region 101 is strategic: In particular, the upper hip joint is perpendicular to the rotational axes of the reaction wheels 202, 203. The rotational axis of each reaction wheel 202, 203 in this implementation has a component in the pitch axis 301 and a component in the roll axis 303 (FIG. 6), whereas the upper hip joint operates in an axis parallel to the yaw axis 302. The lower hip joint is distal to the upper hip joint along the length of the leg and operates in an axis that is perpendicular to that of the first hip joint. The orientation of the lower hip joint depends on the position of the upper hip joint. When the two legs of the robot are parallel to each other, the lower hip joints on both legs would align with each other and would be parallel with the pitch axis 301. In this orientation, the hip region 101 would see the pitch torque generated by the reaction wheels 202, 203 and would need sufficient torque capacity to oppose the reaction wheels' torque. Hence, it may be best to avoid parallel leg orientation in the static balancing mode, to prevent excessive torque requirement at the hip region 101.

More complex control schemes where the leg motors are contributing to the overall balance are also contemplated. This may enable redundancy in balancing where both the reaction wheels and the legs contribute to balancing. In such an implementation, both the leg and the reaction wheels may be controlled in torque mode.

The implementation shown in FIG. 6 is a viable practical humanoid system that can operate with direct-drive actuation on all joints. Other implementations following the same approach, i.e., using one or more reaction wheels in the chest and strategically located springs at the joints, are also contemplated. For instance, additional active or passive degrees of freedom can be added to the legs or torso to increase the range of motion or functionality of the system. The additional joints may or may not have spring elements associated with them.

In some implementations, control moment gyroscopes can be used instead of reaction wheels. A moderately sized gyroscope running at a moderate speed would be sufficient, since the torque requirement is lower, as the spring elements supplement the joint torques.

In some implementations, some of the active joints can have a gear reduction to increase the torque available at the joint. Further, in some implementations, additional degrees of freedom can be provided between the legs and the torso to increase the range of motion of the robot.

In some implementations, the feet are more similar to point contacts than flat contacts. Because the quasi-point contact reduces the area of the contact of the fee, the spring at the ankle joint can be eliminated, which maybe advantageous.

In some implementations, the ankle joint can be eliminated altogether, such that the leg has only a hip joint and a knee joint, and the shin of the robot terminates in a ball contact at the floor. Balancing can be done entirely by the reaction wheel in such implementations.

The implementations described here are only a subset of those feasible using this approach, i.e., and not all possible implementations are described in this disclosure.

### Summary of Selected Example Implementations

The following examples summarize at least some of the implementations described herein:

1. A robot may include: a torque generator to generate a torque; and a leg system including one or more legs, movably coupled to and supporting the torque generator, each leg of the plurality of legs including a first leg member; a second leg member; a first joint movably coupling the first leg member and the second leg member, and a first linear elasticity element coupled between the first leg member and the second leg member across the first joint, the first linear elasticity element being disposed to provide a first force when the first linear elasticity element is actuated that, in combination with the torque, facilitates maintaining an upright position of the robot.

2. The robot as example 1 describes, wherein the torque generator may include a reaction wheel.

3. The robot as either of examples 1 or 2 describe, wherein the torque generator may include a plurality of reaction wheels disposed non-parallel to each other.

4. The robot as any of examples 1-3 describe, wherein the torque generator may include a control moment gyroscope.

5. The robot as any of examples 1˜4 describe, wherein the torque generator may include a plurality of control moment gyroscopes.

6. The robot as any of examples 1-5 describe, wherein the first linear elasticity element is a spring.

7. The robot as any of examples 1-6 describe, wherein the spring is a bidirectional spring.

8. The robot as any of examples 1-7 describe, wherein the first joint is actuatable by a direct-drive actuator.

9. The robot as any of examples 1-8 describe, wherein the first joint is an ankle joint of a leg of the one or more legs, the leg further including a knee joint and a hip joint.

10. The robot as any of examples 1-9 describe, further may include a torso containing the torque generator, wherein the one or more legs are movably coupled to and support the torso.

11. The robot as any of examples 1-10 describe, wherein each leg of the one or more legs further includes: a third leg member; and a second joint movably coupling the third leg member to either the first leg member or the second leg member, and a second linear elasticity element coupled across the second joint, the second linear elasticity element being disposed to provide a second force when the second linear elasticity element is actuated that facilitates maintaining the upright position of the robot.

12. The robot as any of examples 1-11 describe, wherein the first joint is an ankle joint of a leg of the one or more legs and the second joint is a knee joint of the leg.

13. The robot as any of examples 1-12 describe, wherein the torque generator may include a plurality of reaction wheels or control moment gyroscopes, that have axes of rotation that are not parallel to each other, to facilitate maintaining the upright position of the robot.

14. The robot as any of examples 1-13 describe, wherein all active joints in each leg of the one or more legs are driven by direct-drive actuators.

15. The robot as any of examples 1-14 describe, wherein the robot has only a single leg.

16. A bipedal robot may include: a torso containing a plurality of reaction wheels disposed non-parallel to each other; and a leg system including a plurality of legs, movably coupled to and supporting the torso, each leg of the plurality of legs including a hip that has a plurality of degrees of freedom, a knee that has at least one degree of freedom, an ankle that has at least one degree of freedom, a first spring coupled across the ankle, and a second spring coupled across the knee.

17. The bipedal robot as example 16 describes, wherein the plurality of reaction wheels are configured to provide a torque, and wherein the first spring and the second spring are disposed to provide spring forces that facilitate maintaining an upright position of the bipedal robot in combination with the torque.

18. The bipedal robot as either of examples 16 or 17 describe, wherein each of the hip, the knee and the ankle is actuatable by at least one direct-drive actuator.

19. A bipedal robot may include: a plurality of reaction wheels; and a leg system including a plurality of legs, movably coupled to and supporting the plurality of reaction wheels, each leg of the plurality of legs including a first leg member; a second leg member; a first joint movably coupling the first leg member and the second leg member, the first joint being actuatable by a first direct-drive actuator, and a first spring coupled between the first leg member and the second leg member across the first joint, the first spring being disposed to provide a first force when the first spring is actuated that, in combination with a torque provided by one or more of the reaction wheels, facilitates maintaining an upright position of the bipedal robot.

20. The bipedal robot as example 19 describes, wherein each leg of the plurality of legs includes a hip joint that has a plurality of degrees of freedom.

21. The bipedal robot as either of examples 19 or 20 describe, wherein each leg of the plurality of legs further includes: a third leg member; and a second joint movably coupling the third leg member to either the first leg member or the second leg member, the second joint being actuatable by a second direct-drive actuator; and a second spring coupled across the second joint, the second spring being disposed to provide a second force when the second spring is actuated that facilitates maintaining the upright position of the bipedal robot.

22. A robot may include: torque means for generating a torque; and a leg system including one or more legs, movably coupled to and supporting the torque means, each leg of the one or more legs including a first leg member; a second leg member; a first joint movably coupling the first leg member and the second leg member, and first elasticity means for providing linearly elastic coupling between the first leg member and the second leg member across the first joint, the first elasticity means being disposed to provide a first force when the first elasticity means is actuated that, in combination with the torque, facilitates maintaining an upright position of the robot.

23. The robot as example 22 describes, wherein the torque means may include a reaction wheel.

24. The robot as either of examples 22 or 23 describe, wherein the torque means may include a plurality of reaction wheels disposed non-parallel to each other.

25. The robot as any of examples 22-24 describe, wherein the torque means may include a control moment gyroscope.

26. The robot as any of examples 22-25 describe, wherein the torque means may include a plurality of control moment gyroscopes.

27. The robot as any of examples 22-26 describe, wherein the first elasticity means is a spring.

28. The robot as any of examples 22-27 describe, wherein the spring is a bidirectional spring.

29. The robot as any of examples 22-28 describe, wherein the first joint is actuatable by a direct-drive actuator.

30. The robot as any of examples 22-29 describe, wherein the first joint is an ankle joint of a leg of the one or more legs, the leg further including a knee joint and a hip joint.

31. The robot as any of examples 22-30 describe, further may include a torso containing the torque means, wherein the one or more legs are movably coupled to and support the torso.

32. The robot as any of examples 22-31 describe, wherein each leg of the one or more legs further includes: a third leg member; and a second joint movably coupling the third leg member to either the first leg member or the second leg member, and a second elasticity means for providing linearly elastic coupling coupled across the second joint, the second elasticity means being disposed to provide a second force when the second linear elasticity element is actuated that facilitates maintaining the upright position of the robot.

33. The robot as any of examples 22-32 describe, wherein the first joint is an ankle joint of a leg of the one or more legs and the second joint is a knee joint of the leg.

34. The robot as any of examples 22-33 describe, wherein the torque means may include a plurality of reaction wheels or control moment gyroscopes, that have axes of rotation that are not parallel to each other, to facilitate maintaining the upright position of the robot.

35. The robot as any of examples 22-34 describe, wherein all active joints in each leg of the one or more legs are driven by direct-drive actuators.

36. The robot as any of examples 22-35 describe, wherein the robot has only a single leg.

Any or all of the features and functions described above can be combined with each other, except to the extent it may be otherwise stated above or to the extent that any such implementations may be incompatible by virtue of their function or structure, as will be apparent to persons of ordinary skill in the art.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A robot comprising:
a torque generator to generate a torque; and
a leg system including one or more legs movably coupled to and supporting the torque generator, each leg of the one or more legs including
a first leg member;
a second leg member;
a first joint movably coupling the first leg member and the second leg member, and
a first linear elasticity element coupled between the first leg member and the second leg member across the first joint, the first linear elasticity element being disposed to provide a first force when the first linear elasticity element is actuated that, in combination with the torque, facilitates maintaining an upright position of the robot.

2. The robot of claim 1, wherein the torque generator comprises a reaction wheel.

3. The robot of claim 1, wherein the torque generator comprises a plurality of reaction wheels disposed non-parallel to each other.

4. The robot of claim 1, wherein the torque generator comprises a control moment gyroscope.

5. The robot of claim 1, wherein the torque generator comprises a plurality of control moment gyroscopes.

6. The robot of claim 1, wherein the first linear elasticity element is a spring.

7. The robot of claim 6, wherein the spring is a bidirectional spring.

8. The robot of claim 1, wherein the first joint is actuatable by a direct-drive actuator.

9. The robot of claim 1, wherein the first joint is an ankle joint of a leg of the one or more legs, the leg further including a knee joint and a hip joint.

10. The robot of claim 1, further comprising a torso containing the torque generator, wherein each leg of the one or more legs is movably coupled to and support the torso.

11. The robot of claim 1, wherein each leg of the one or more legs further includes:
a third leg member; and
a second joint movably coupling the third leg member to either the first leg member or the second leg member, and
a second linear elasticity element coupled across the second joint, the second linear elasticity element being disposed to provide a second force when the second linear elasticity element is actuated that facilitates maintaining the upright position of the robot.

12. The robot of claim 11, wherein the first joint is an ankle joint of a leg of the one or more legs and the second joint is a knee joint of the leg.

13. The robot of claim 1, wherein the torque generator comprises a plurality of reaction wheels or control moment gyroscopes, that have axes of rotation that are not parallel to each other, to facilitate maintaining the upright position of the robot.

14. The robot of claim 1, wherein all active joints in each leg of the one or more legs are driven by direct-drive actuators.

15. The robot of claim 1, wherein the robot has only a single leg.

16. A bipedal robot comprising:
a torso containing a plurality of reaction wheels disposed non-parallel to each other; and
a leg system including a plurality of legs, movably coupled to and supporting the torso, each leg of the plurality of legs including
a hip that has a plurality of degrees of freedom,
a knee that has at least one degree of freedom,
an ankle that has at least one degree of freedom,
a first spring coupled across the ankle, and
a second spring coupled across the knee.

17. The bipedal robot of claim 16, wherein the plurality of reaction wheels are configured to provide a torque, and wherein the first spring and the second spring are disposed to provide spring forces that facilitate maintaining an upright position of the bipedal robot in combination with the torque.

18. The bipedal robot of claim 16, wherein each of the hip, the knee and the ankle is actuatable by at least one direct-drive actuator.

19. A bipedal robot comprising:
a plurality of reaction wheels; and
a leg system including a plurality of legs, movably coupled to and supporting the plurality of reaction wheels, each leg of the plurality of legs including
a first leg member;
a second leg member;
a first joint movably coupling the first leg member and the second leg member, the first joint being actuatable by a first direct-drive actuator, and
a first spring coupled between the first leg member and the second leg member across the first joint, the first spring being disposed to provide a first force when the first spring is actuated that, in combination with a torque provided by one or more of the reaction wheels, facilitates maintaining an upright position of the bipedal robot.

20. The bipedal robot of claim 19, wherein each leg of the plurality of legs includes a hip joint that has a plurality of degrees of freedom.

21. The bipedal robot of claim 20, wherein each leg of the plurality of legs further includes:
a third leg member; and
a second joint movably coupling the third leg member to either the first leg member or the second leg member, the second joint being actuatable by a second direct-drive actuator; and
a second spring coupled across the second joint, the second spring being disposed to provide a second force when the second spring is actuated that facilitates maintaining the upright position of the bipedal robot.
